(19) United States
(12) Patent Application Publication
(10) Pub. No.: US 2007/0182514 A1
(43) Pub. Date: Aug. 9, 2007

(54) Control cartridge and control handle including same

(75) Inventors: Michael C. Brandl, Grayslake, IL (US); Richard C. Barthel, Libertyville, IL (US); Anthony J. Novelle, Glen Ellyn, IL (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 10/575,504

(22) PCT Filed: Oct. 22, 2004
(86) PCT No.: PCT/US04/35017

§ 371 Date: Apr. 2, 2007

Related U.S. Application Data
(60) Provisional application No. 60/513,644, filed on Oct. 23, 2003.

(51) Int. Cl. H01H 77/04; B62K 21/26

(52) U.S. Cl. 335/37; 74/551.9

(57) ABSTRACT

A control cartridge has a circuit board that includes a Hall effect sensor, the position of which is fixed in a housing that has a cam. The control cartridge includes a shaft that carries a magnet and that rotates and translates with respect to the housing. The shaft has a cam follower that engages the cam and translates the shaft with respect to the housing when the shaft is rotated with respect to the housing in one direction but not in an opposite direction. The control cartridge is shown as part of a control handle for a motorcycle in which the relative angular position of the shaft with respect to the Hall effect sensor is used to control engine speed manually while the relative axial position of the shaft with respect to the Hall effect sensor is used to deactivate a cruise control.

### RELATED PATENT APPLICATION

Priority of Provisional Patent Application No. 60/513,644 filed Oct. 23, 2003 is claimed.

### TECHNICAL FIELD

This invention relates to a control cartridge and a control handle including the control cartridge.

### BACKGROUND OF THE INVENTION

Control handles are often used for controlling the speed of a vehicle that is steered by a handle bar, such as a motorcycle, a snow mobile or a personal watercraft. Such vehicles, for instance, a high end motorcycle may also be equipped with cruise control to maintain a set speed. See for instance, U.S. Pat. No. 5,881,833 granted to Matthew G. Branch et al Mar. 16, 1999, which has a control handle or handgrip to control the throttle of an engine manually as well as deactivate cruise control.

### SUMMARY OF THE INVENTION

The control cartridge and control handle of the invention uses a Hall effect sensor to send electrical input signals to control two devices, for instance, an engine throttle control device and a cruise control device. The control cartridge includes a circuit board that carries a Hall effect sensor which sends the electrical input signals to the two controlled devices and preferably includes a second redundant Hall effect sensor to check the electrical input signals that are sent. Optional features of the invention include traces on the circuit board for wires to heat the hand grip of the control handle and/or a collar or the like for limiting the rotation of the hand grip.

The control cartridge of the invention preferably includes a cam that produces a linear motion responsive to one direction of rotation of the hand grip so that the rotation of the hand grip in the opposite direction controls one device while the linear motion produced in the one direction of rotation controls another device. Such a control cartridge can be used for instance in a motor cycle equipped with cruise control where the rotation of a hand grip can be used primarily for manual speed control while linear motion produced in the one direction of rotation of the hand grip can be used to deactivate the cruise control.

### BRIEF DESCRIPTION OF THE DRAWING

FIG. 1 is a schematic sectional view of a control handle having a control cartridge in accordance with the invention;

FIG. 2 is an exploded perspective view of the control cartridge;

FIG. 3 is a sectional perspective view of the control cartridge shown in a first operative position, e.g. low idle;

FIG. 4 is another sectional perspective of the control cartridge shown in the first operative position;

FIG. 5 is a section taken substantially along the line 5-5 of FIG. 4 looking in the direction of the arrows;

FIG. 6 is a sectional perspective view of the control cartridge shown in a second operative position, e.g. full throttle;

FIG. 7 is a section taken substantially along the line 7-7 of FIG. 6 looking in the direction of the arrows;

FIG. 8 is a sectional perspective view of the control cartridge shown in a third operative position, e.g. cruise release; and

FIG. 9 is a section taken substantially along the line 9-9 of FIG. 8 looking in the direction of the arrows.

### DETAILED DESCRIPTION OF PREFERRED EMBODIMENT

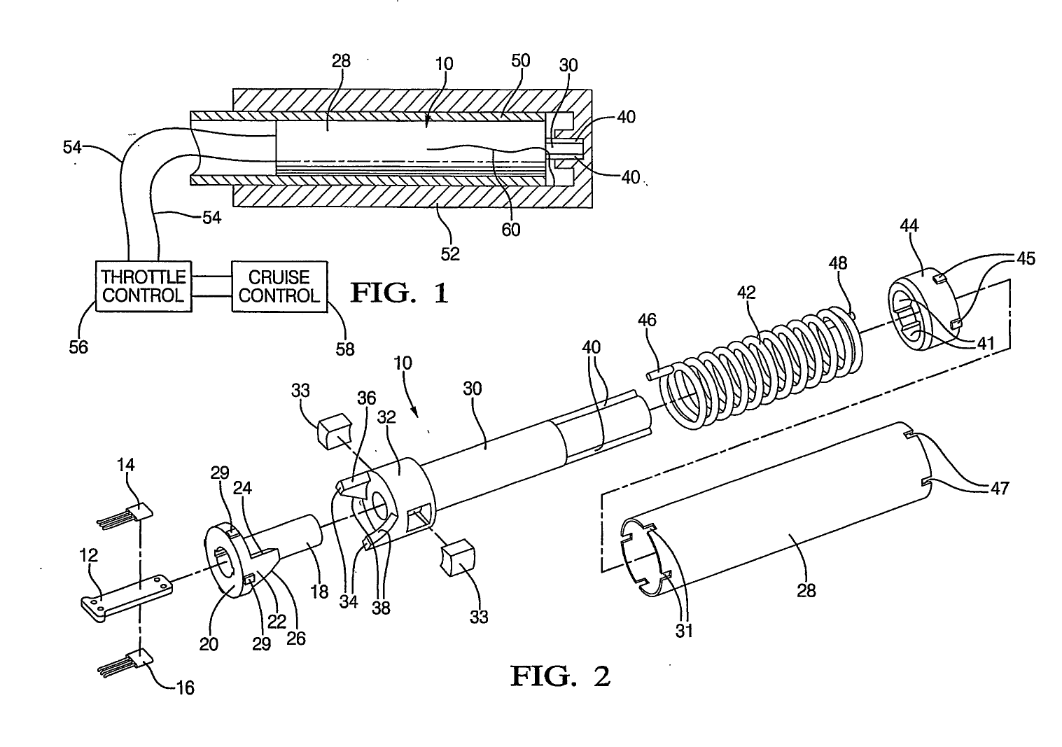

Referring now to FIG. 1, the invention may include a control cartridge 10 that can be inserted into a handle bar of a motor cycle or other self propelled vehicle that is steered by a handle bar. Cartridge 10 transmits an electric signal that allows the operator to control one device such as an engine throttle control device and a second device such as a cruise control device.

Control cartridge 10 comprises a circuit board 12 having conductive traces formed into electrical circuits (not shown). A first Hall effect sensor 14 is mounted on one side of the circuit board 12 while a second redundant Hall effect sensor 16 is preferably mounted on the opposite side of the circuit board 12. One Hall effect sensor is sufficient for sending an electric control signal, however, two interconnected Hall effect sensors are preferable for enhanced accuracy of the electric signals that are generated by the Hall effect sensors that electronically sense the rotation and longitudinal motion of a shaft as explained below. Circuit board 12 may also include conductive traces for electrical circuits to heat a hand grip as explained below.

Circuit board 12 is non-rotationally fixed in a housing 18 that has a flange 20 at one end and two exterior, diametrically opposed, longitudinal lugs 22 extending rearwardly from the flange 20. Each lug has a trapezoidal shape with an axial stop surface 24 on one side and a slanted cam surface 26 on the other side. Housing 18 is disposed in a tube 28 with flange 20 non-rotationally fixed in the tube 28 at one end and has radial lugs 29 that are disposed in key slots 31 in the forward end of tube 28. Tube 28 is preferably stainless steel.

Control cartridge 10 further comprises a rotatable shaft 30 that is disposed in tube 28 and rotatably mounted on housing 18 at one end. Shaft 30 has an enlarged head 32 at the rotatably mounted end that supports two diametrically opposed permanent magnets 33 that cooperate with the Hall effect sensors 14 and 16 respectively. Two diametrically opposed, longitudinal lugs 34 extend forwardly from head 32. Each lug 34 has a trapezoidal shape with an axial stop surface 36 on one side and a slanted cam follower surface 38 on the other side. Shaft 30 has two diametrically opposed, elongate, longitudinal splines 40 at an opposite end of reduced diameter.

Control cartridge 10 further comprises a coiled compression/torsion spring 42 and a collar 44. Spring 42 is disposed in tube 28 surrounding the central portion of shaft 30 between head 32 and collar 44 which is non-rotatably secured in the end of tube 28 and has radial lugs 45 that are disposed in key slots 47 in the rearward end of tube 28. Spring 42 has a tab 46 at one end that is secured to head 32 and a tab 48 at the opposite end that is secured to collar 44. The splined end of shaft 30 extends through collar 44 for connection to a handgrip as explained below.

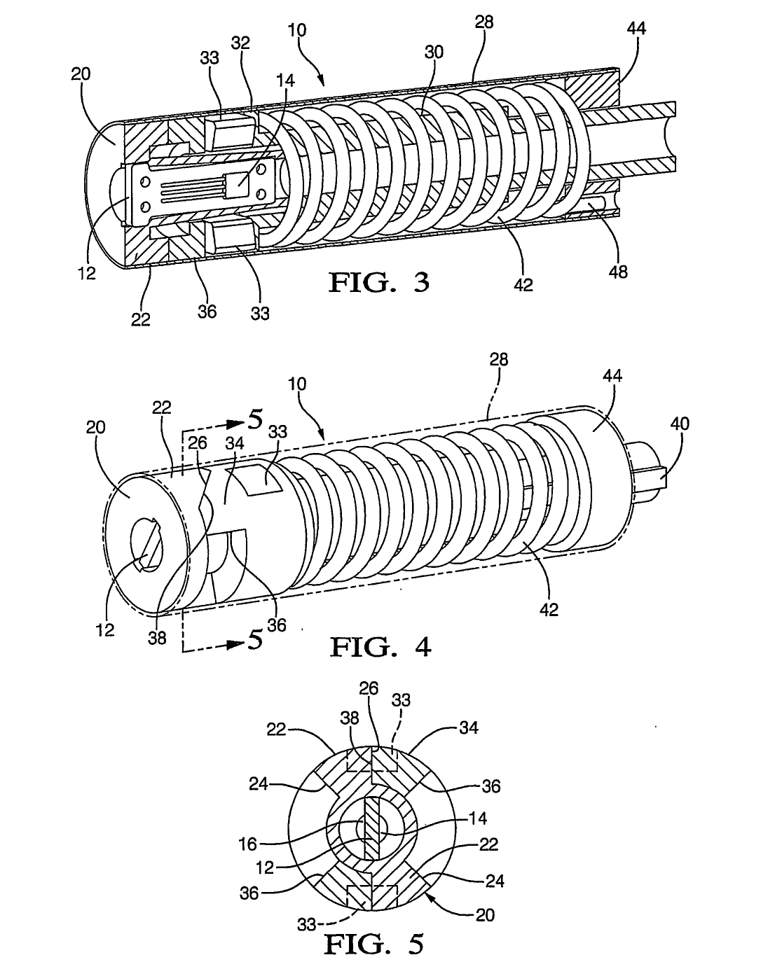

Splines 40 are disposed in slots 41 in the inner surface of collar 44; the slots limiting the rotation of the shaft 30 with respect to tube 28 and the housing 20 that is non-rotatably secured to the opposite end of tube 28. When cartridge 10 is assembled, spring 42 is twisted so that the slanted cam follower surfaces 38 of lugs 34 are biased counter-clockwise into engagement with the slanted cam surfaces 26 of lugs 22 as best shown in FIGS. 3, 4 and 5. In a typical throttle control for a motor cycle application, this position is the low idle position. The Hall effect sensors 14 and 16 sense the angular position of the permanent magnets 33 by sensing a predetermined magnitude of the magnetic flux density of the permanent magnets 33 and send an electric signal to any suitable electronic control device (not shown) that sets the throttle at a low idle position. Spring 42 produces compressive forces as well as torsional forces. The compressive forces are stronger than the torsional forces so that the spring 42 acting in concert with the engaging cam and cam follower surfaces 26, 38 does not push shaft 30 counterclockwise past this low idle position. In the low idle position, the axial stop surfaces 36 of lugs 34 are spaced about 90 degrees ahead of the axial stop surfaces 24 of the fixed lugs 22.

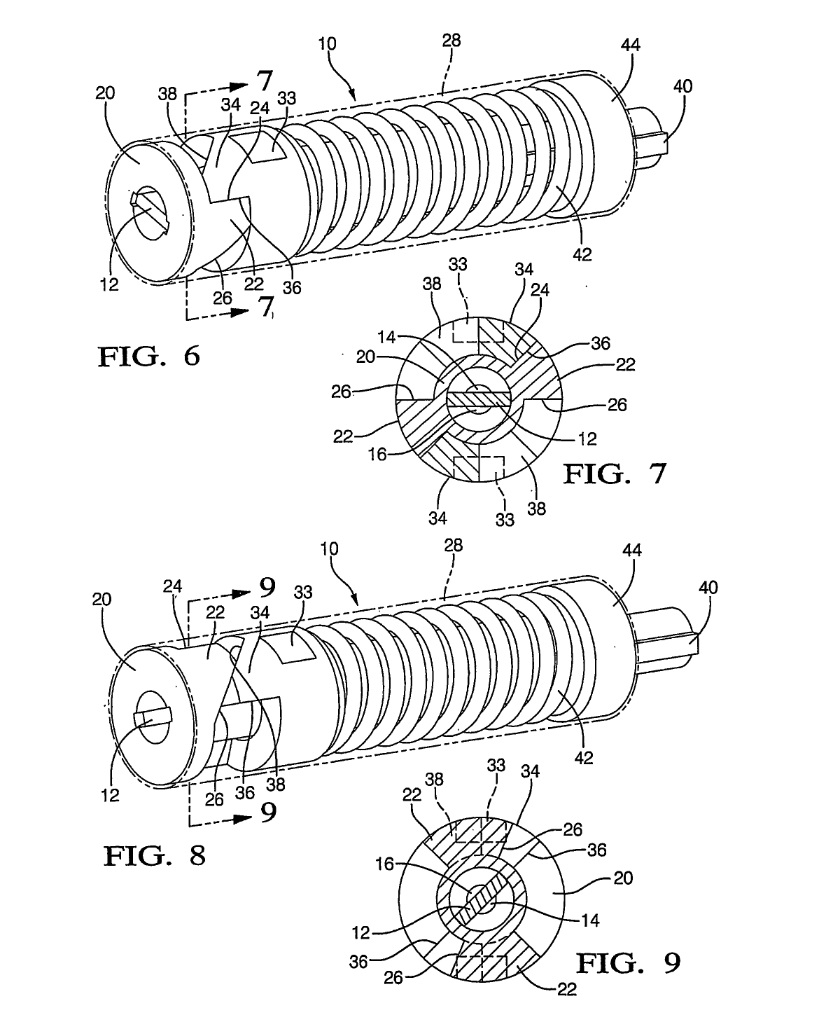

For acceleration, the shaft 30 is rotated manually clockwise which is conventionally referred to as the positive direction. As shaft 30 is rotated in the positive direction, the Hall effect sensors 14 and 16 sense the change of magnetic flux density, preferably an increase in magnetic flux density as the permanent magnets 33 are rotated into closer and closer proximity to the Hall effect sensors 14 and 16. The Hall effect sensors 14 and 16 in turn send the new signals via the circuit board 12 to the electronic control device (not shown) which changes the throttle setting. Manual rotation of the shaft 30 in the positive direction is limited by stop surfaces 36 of lugs 34 engaging the stop surfaces 24 of fixed lugs 22. Rotation is also preferably limited by splines 40 engaging the ends of the slots 41 in collar 44. This is the full throttle position illustrated in FIGS. 6 and 7.

The Hall effect sensors 14 and 16 also sense the longitudinal displacement of the permanent magnets 33 with respect to the sensors 14 and 16. This longitudinal displacement may be use to control another device such as a cruise control device. When a motor cycle or the like is equipped with cruise control, the cruise control is normally set at a desired speed and then the shaft 30 is released. The shaft 30 is then moved in the negative direction or counterclockwise direction by spring 42 and returned to the low idle position shown in FIGS. 3, 4 and 5. As indicated above, spring 42 is designed so that spring 42 can not move shaft 30 in the negative direction past the low idle position. In any event, release of shaft 30 does not effect the cruise control device because the position of magnets 33 does not change in the longitudinal direction, only in the rotational or circumferential direction. To deactivate or disengage the cruise control device, shaft 30 is moved counter-clockwise, that is, in the negative direction past the low idle position shown in FIGS. 3, 4 and 5 manually. Cam follower surfaces 38 being engaged with the fixed cam surfaces 26, drive shaft 30 is driven rearwardly (that is, toward the right as viewed in FIGS. 1, 2, 3 and 4) when shaft 30 is so moved. Hall effect sensors 14 and 16 sense the decrease in magnetic flux density caused by the longitudinal displacement of permanent magnets 33 away from the Hall effect sensors 14 and 16 and generate an electric control signal that is sent via circuit board 12 which deactivates the cruise control device so that vehicle speed is now controlled manually.

Referring now to FIGS. 1 and 2, control cartridge 10 is installed by inserting cartridge 10 into an open end of a tubular handle bar 50. Radial lugs 29 and 45 are sized to fit snuggly in the handle bar 50 so that tube 28 does not move in either the longitudinal or the rotational direction when shaft 30 is rotated or extended out the end of tube 28 by rotation in a negative direction. When control cartridge 10 is installed, the splined end of shaft 30 sticks out of the open end of handle bar 50. The protruding splined end of shaft 30 is then non-rotationally connected to a hand grip 52 that is slid onto the exterior of the handle bar 50 for rotation relative to the handle bar. In the typical installation of FIG. 1, lead wires 54 extend from the circuit board 12 through the interior of the handle bar 50 to control engine speed manually via an engine throttle control 56 that includes a suitable electronic throttle control (not shown) and to deactivate a cruise control 58 via a suitable electronic control (not shown). A lead wire 60 to hand grip 52 for heating hand grip 52 may also route internally within the handle bar 50.

In operation a positive manual rotation of hand grip 52 determines the throttle speed setting while a negative manual rotation accompanied by a longitudinal motion of hand grip 52 deactivates the cruise control. The housing 18 for the circuit board 12 positions the circuit board within the tube 28 and the handle bar 50 and also contains the fixed slanted cam surfaces 26. The magnets 33 supply the required magnetic field. The shaft 30 transmits the torsional input from the hand operated grip 52 to the magnets 33. With cruise control enabled, the shaft 30 can rest in the low idle position; the slanted cam follower surface 38 of the shaft 30 resting against the fixed slanted cam surface 26 of the housing 18. A negative manual grip rotation beyond the low idle position causes both a rotational and longitudinal motion of the magnets 33. This results in the cruise control being disengaged. The spring 42 is used in both torsion and compression. In torsion, the spring 42 provides feel and return to the hand grip 52. In compression with the cruise engaged, the spring 42 keeps the sensor in the low idle position and requires a higher operator effort to disengage the cruise control. The collar 44 limits the rotation of the hand grip 52, retains the spring 42 in the tube 28, retains the mechanism parts in the tube 28, and the control cartridge 10 in the open end of the handle bar 50. The tube 28 constrains the assembly and is part of the magnetic field circuit.

While the invention has been explained in connection with a control handle for a motor cycle, the invention is virtually for any application where a control cartridge or control handle is used, such as machinery, large and small, pipeline drilling equipment, medical instruments, drills, pumps, four wheelers, personal watercraft, snowmobiles or any self propelled vehicle that is steered with a handle bar. Moreover, while the invention has been explained in connection with a preferred embodiment that has a stationary Hall effect sensor or sensors and moveable permanent magnets, it is also possible to design a control cartridge with other configurations, such as a stationary magnet and a moveable Hall effect sensor, so long as the magnetic flux density changes with rotation as well as longitudinal displacement. With regard to the changes in the magnetic flux density, the preferred embodiment increases the magnetic flux density to sense rotation from a set point and control one device while the preferred embodiment decreases the magnetic flux density from the set point to sense longitudinal displacement and control a second device. However, it is also possible to design a control cartridge where a decreased magnetic flux density senses rotation from the set point and controls one device while increased magnetic flux density from the set point senses longitudinal displacement and controls a second device. In other words, the invention is not to be limited except by the appended claims and their equivalents.

We claim:

1. A control cartridge comprising:
a first member that carries a Hall effect sensor,
a second member that carries a magnet and that rotates and translates with respect to the first member,
means to position the first member with respect to the second member so that the Hall effect sensor senses a predetermined magnetic flux density of the magnet,
means to change the magnetic flux density sensed by the Hall effect sensor in one direction responsive to rotation of the second member with respect to the first member in a first direction, and
means to change the magnetic flux density sensed by the Hall effect sensor in an opposite direction responsive to translation of the second member with respect to the first member.

2. The control cartridge as defined in claim 1 wherein the magnetic flux density sensed by the Hall effect sensor is increased responsive to the rotation of the second member with respect the first member in the first direction, and
the magnetic flux density sensed by the Hall effect sensor is decreased responsive to translation of the second member with respect to the first member.

3. The control cartridge as defined in claim 1 including a cam carried by one of the first and second members and a cam follower carried by another of the first and second members, the cam follower moving away from the cam responsive to rotation of the second member with respect to the first member in the first direction and engaging the cam and translating the another of the first and second members with respect to the one of the first and second members responsive to rotation of the second member with respect to the first member in an opposite direction.

4. The control handle as defined in claim 3 wherein the magnetic flux density sensed by the Hall effect sensor is increased responsive to the rotation of the second member with respect the first member in the first direction, and the magnetic flux density sensed by the Hall effect sensor is decreased responsive to translation of the second member with respect to the first member.

5. A control cartridge comprising:
a circuit board that includes a Hall effect sensor,
a housing for fixing the position of the Hall effect sensor; the housing having a cam, and
a shaft that carries a magnet and that rotates and translates with respect to the housing; the shaft having a cam follower that engages the cam and translates the shaft with respect to the housing when the shaft is rotated with respect to the housing in one direction but not in an opposite direction.

6. A control handle for a vehicle that is steered by a tubular handle bar and that has an engine control device and a cruise control device, the control handle comprising:
a control cartridge disposed in an open end of the tubular handle bar, and
a hand grip rotatably mounted on the exterior of the handle bar adjacent the open end,
the control cartridge including a circuit board upon which a Hall effect sensor is mounted,
a housing receiving the circuit board and fixing the position of the Hall effect sensor; the housing being non-rotatably mounted in the end of a tube and having a cam,
a shaft inside the tube that carries a magnet and that rotates and translates with respect to the housing; the shaft having a cam follower that engages the cam and translates the shaft with respect to the housing when the shaft is rotated with respect to the housing in one direction but not in an opposite direction,
a collar non-rotatably mounted in an opposite end of the tube,
a spring disposed in the tube and biasing the shaft rotationally so that the cam follower engages the cam;
the collar being disposed in the tubular handle bar snuggly, and
the shaft having an end that protrudes out of the collar; the end being non-rotatably attached to the hand grip.

7. A control cartridge comprising:
a first member that carries a Hall effect sensor,
a second member that carries a magnet and that rotates and translates with respect to the first member,
a cam carried by one of the first and second members and a cam follower that is carried by another of the first and second members and biased into engagement with the cam to position the first member with respect to the second member so that the Hall effect sensor senses a predetermined magnetic flux density of the magnet,
means to change the magnetic flux density sensed by the Hall effect sensor in one direction responsive to rotation of the second member with respect to the first member in a first direction, and
means to change the magnetic flux density sensed by the Hall effect sensor in an opposite direction responsive to translation of the second member with respect to the first member.

8. The control cartridge as defined in claim 7 wherein the magnetic flux density sensed by the Hall effect sensor is increased responsive to the rotation of the second member with respect the first member in the first direction, and the magnetic flux density sensed by the Hall effect sensor is decreased responsive to translation of the second member with respect to the first member.

9. The control cartridge as defined in claim 7 wherein the cam follower moves away from the cam responsive to rotation of the second member with respect to the first member in the first direction and translates the another of the first and second members with respect to the one of the first and second members responsive to rotation of the second member with respect to the first member in an opposite direction.

10. The control cartridge as defined in claim 9 wherein the magnetic flux density sensed by the Hall effect sensor is increased responsive to the rotation of the second member with respect the first member in the first direction, and
the magnetic flux density sensed by the Hall effect sensor is decreased responsive to translation of the second member with respect to the first member.
